(19) United States
(12) Patent Application Publication
(10) Pub. No.: US 2026/0296298 A1
(43) Pub. Date: Oct. 1, 2026

(54) CONTROL APPARATUS FOR VEHICLE HEADLIGHT, VEHICLE HEADLIGHT SYSTEM

(71) Applicant: Stanley Electric Co., Ltd., Tokyo (JP)

(72) Inventor: Masahiro MITA, Tokyo (JP)

(21) Appl. No.: 19/480,477

(22) PCT Filed: Apr. 23, 2024
(86) PCT No.: PCT/JP2024/015897

§ 371 Date: Oct. 31, 2025

(30) Foreign Application Priority Data
May 1, 2023 (JP) 2023-075527

(51) Int. Cl. B60Q 1/14

(52) U.S. Cl. CPC B60Q 1/143; B60Q 2300/054; B60Q 2300/41

(57) ABSTRACT

A control apparatus for a vehicle headlight that, when a difference between a first position indicating the position of a first light-emitting portion and the right end position of a forward vehicle is equal to or less than a first reference value, or when a difference between the first position and the left end position of the forward vehicle is less than a second reference value, determines a second position indicating the position of an undetected second light-emitting portion in the forward vehicle based on the first position, the right and left end position, and the relative distance between the forward vehicle and an own vehicle, uses the first and second position to set a light distribution pattern having a dimming range according to the position of the forward vehicle, and generates a control signal according to the light distribution pattern and supplies it to the vehicle headlight.

This application is a U. S. National Stage Application under 35 U.S.C § 371 of International Patent Application No. PCT/JP2024/015897 filed Apr. 23, 2024, which claims the benefit of priority under 35 U.S. C. § 119 to Japanese Patent Application No. 2023-075527 filed May 1, 2023, the disclosures of all of which are hereby incorporated by reference in their entireties.

### TECHNICAL FIELD

The present disclosure relates to a control apparatus for a vehicle headlight and a vehicle headlight system.

### BACKGROUND ART

Conventionally, a technique for controlling light distribution of a vehicle headlight has been known, primarily by dimming a certain range within a high beam illumination range depending on the position of other vehicles (e.g., a preceding vehicle, an oncoming vehicle, or the like) present in front of an own vehicle (for example, refer to Japanese Patent Application Laid-Open No. 2020-026248). In general, the position of light sources such as headlights and taillights of other vehicles are detected using image processing or the like, and a dimming range is set based on the positions of the light sources. At this time, when a pair of light sources is detected, the other vehicle is determined to be a four-wheel vehicle, and when one light source that is not paired is detected, it can be determined that the other vehicle is a two-wheel vehicle, and therefore, the width of the dimming range, etc. is set accordingly, thereby reducing the glare on the other vehicles.

However, for example, if one of the headlights or taillights of a four-wheel vehicle fails or is blocked for some reason, the light sources are detected as a single light source rather than as a pair, and the dimming range is set for a two-wheel vehicle, which may be inappropriate for the four-wheel vehicle.

### PRIOR ART DOCUMENT

### Patent Document

[Patent Document 1] Japanese Patent Application Laid-Open No. 2020-026248

### SUMMARY OF THE INVENTION

### Technical Problem

In a specific aspect, it is an object of the present disclosure to provide a light distribution control technology capable of more appropriately setting a dimming range.

### Solution to the Problem

(1) A control apparatus according to one aspect of the present disclosure is a control apparatus for a vehicle headlight in which a light distribution pattern is variable including: (a) a first sensor configured to detect at least a first position indicating a position of a first light-emitting portion of a forward vehicle; (b) a second sensor configured to detect a right end position and a left end position of the forward vehicle as seen from an own vehicle, a first distance indicating a relative distance between the right end position and the own vehicle, and a second distance indicating a relative distance between the left end position and the own vehicle, and (c) a controller configured to connect each of the first sensor, the second sensor, and the vehicle headlight, and configured to control the operation of the vehicle headlight;
(d) wherein, when the difference between the first position and the right end position is equal to or less than a first reference value or when the difference between the first position and the left end position is equal to or less than a second reference value, the controller obtains a second position indicating a position of a second light-emitting portion of the forward vehicle that is not detected by the first sensor on the basis of the first position, the right end position, the left end position, the first distance, and the second distance, sets a light distribution pattern having a dimming range corresponding to the position of the forward vehicle by using the first position and the second position, and generates a control signal corresponding to the light distribution pattern and supplies it to the vehicle headlight.
(2) A control method according to one aspect of the present disclosure is a control method executed by a controller connected to a vehicle headlight with a variable light distribution pattern, (a) wherein the controller is connected to a first sensor configured to detect a first position indicating the position of a first light-emitting portion of a forward vehicle, and a second sensor configured to detect a right end position and a left end position of the forward vehicle as seen from an own vehicle, a first distance indicating a relative distance between the right end position and the own vehicle, and a second distance indicating a relative distance between the left end position and the own vehicle, and
(b) wherein, the controller executes, (b1) when the difference between the first position and the right end position is equal to or less than a first reference value or when the difference between the first position and the left end position is equal to or less than a second reference value, to obtain a second position indicating a position of a second light-emitting portion of the forward vehicle that is not detected by the first sensor on the basis of the first position, the right end position, the left end position, the first distance, and the second distance, (b2) to set a light distribution pattern having a dimming range corresponding to the position of the forward vehicle by using the first position and the second position, and (b3) to generate a control signal corresponding to the light distribution pattern and supplies it to the vehicle headlight.
(3) A vehicle headlight system according to one aspect of the present disclosure is a vehicle headlight system including the control apparatus according to the above-described (1), and a vehicle headlight controlled by the control apparatus.

According to the above configurations, there is provided a light distribution control technology capable of more appropriately setting a dimming range.

### BRIEF DESCRIPTION OF THE DRAWINGS

FIG. 1(A) is a diagram showing a configuration of a vehicle headlight system according to one embodiment.

FIG. 1(B) is a diagram showing a configuration example of a computer system.

FIG. 2(A) is a diagram for explaining light source information of a forward vehicle detected by the camera.

FIG. 2(B) is a diagram for explaining object information of a forward vehicle detected by the camera.

FIG. 3(A) is a diagram for specifically explaining light source information.

FIG. 3(B) is a diagram for specifically explaining object information.

FIG. 3(C) is a diagram for explaining data structure of the light source information and the object information.

FIG. 4(A) is a diagram for explaining an example of transmission data of the light source information.

FIG. 4(B) is a diagram for explaining an example of transmission data of the object information.

FIG. 5(A) to FIG. 5(D) are diagrams for explaining a situation assumed when “one light” is detected as the light source information.

FIG. 6 is a flowchart showing an operation procedure of a vehicle headlight system.

FIG. 7 is a diagram for explaining a specific example of light distribution control executed in step S14.

FIG. 8(A) is a diagram for explaining an example of a light distribution pattern realized by the present embodiment.

FIG. 8(B) is a diagram for explaining a light distribution pattern of a comparative example.

### MODE FOR CARRYING OUT THE INVENTION

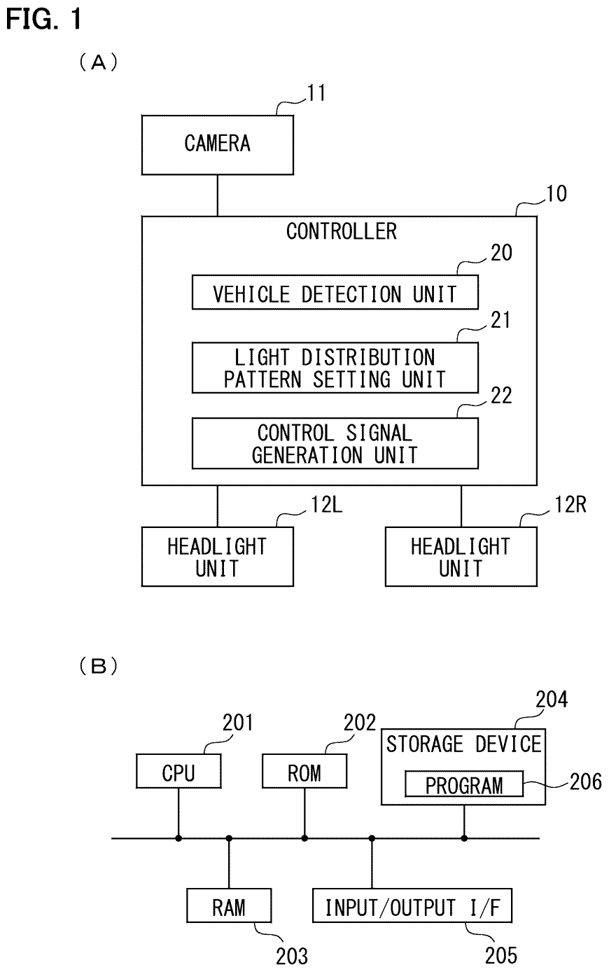

FIG. 1(A) is a diagram showing a configuration of a vehicle headlight system according to one embodiment. The illustrated vehicle headlight system is configured to include a controller 10, a camera 11, and a pair of headlight units 12L and 12R. The vehicle headlight system is for performing light irradiation to the front of an own vehicle. Here, in the present specification, controller 10 and camera 11 constitute a control apparatus for a vehicle headlight.

Controller 10 controls the operation of light irradiation by each of the headlight units 12L and 12R. This controller 10 can be configured using a computer system as illustrated in FIG. 1(B), that is, a computer system including a processor (CPU: Central Processing Unit) 201, a ROM (Read Only Memory) 202, a RAM (Random Access Memory) 203, a storage device 204 such as a flash memory, an input/output interface 205, and the like. Controller 10 of the present embodiment is brought into a state in which it can perform each of the functions described below by having the processor read and execute a program 206 stored in advance in the storage device 204.

Camera 11 performs predetermined image recognition processing based on image data obtained by capturing images of the space in front of the own vehicle, thereby detecting the location of a forward vehicle (a preceding vehicle, an oncoming vehicle) and a pedestrian, and the like.

Here, part or all of the functions of the image recognition processing may be provided on controller 10 side. In this case, image data is supplied from camera 11 to controller 10, and controller 10 executes a predetermined program to perform the image recognition processing.

Controller 10 includes a vehicle detection unit 20, a light distribution pattern setting unit 21, and a control signal generation unit 22 as functional blocks realized by program execution.

Vehicle detection unit 20 detects information indicating the actual position of the forward vehicle or the like based on the detection results of the forward vehicle or the like by camera 11.

Light distribution pattern setting unit 21 sets the light distribution pattern of the irradiation light emitted by each headlight unit 12L, 12R based on the detection results of the forward vehicle or the like by vehicle detection unit 20.

Control signal generation unit 22 generates control signals to cause each headlight unit 12L, 12R to form irradiation light according to the light distribution pattern set by light distribution pattern setting unit 21, and supplies these control signals to each headlight unit 12L, 12R.

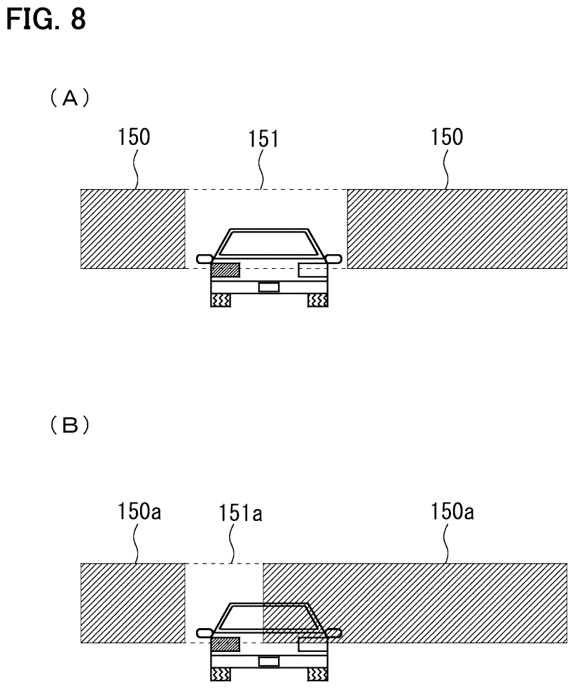

The pair of headlight units 12L, 12R are mounted at predetermined positions on the left and right sides of the front of the own vehicle and operate in accordance with control signals supplied from controller 10 to form light emitted to the front of the own vehicle. The headlight units 12L and 12R of the present embodiment can variably set a light distribution pattern, can form each irradiation light of a low beam (passing light) and a high beam (traveling light), and can form an adaptive driving beam (ADB) which is an irradiation light 150 configured by providing a dimming range 151 corresponding to the position of the forward vehicle within the irradiation range of the high beam as shown in FIG. 8(A) described later.

Various known configurations can be adopted as the headlight units 12L and 12R. For example, a high beam, a low beam, and an additional beam can be formed by a lamp unit combining a light source bulb with a reflector and/or a shielding plate. Further, an adaptive driving beam can be formed by using a lamp unit that has light-emitting elements such as LEDs (light-emitting diodes) arranged in one or two directions and allows the lighting state of each element to be individually controlled. Further, an adaptive driving beam can be formed by using a lamp unit equipped with a light source and a liquid crystal element, etc., and that allows the light transmission state of each pixel of the liquid crystal element to be individually controlled. Further, an adaptive driving beam can be formed by using a lamp unit equipped with a light-emitting element such as a laser diode and a scanning element such as a mirror device that scans the light emitted from the light-emitting element, and that allows the timing of the on/off of the light-emitting element and the scanning timing of the scanning element to be controlled. Furthermore, a high beam and a low beam may be formed in addition to the adaptive driving beam in the lamp unit having these configurations.

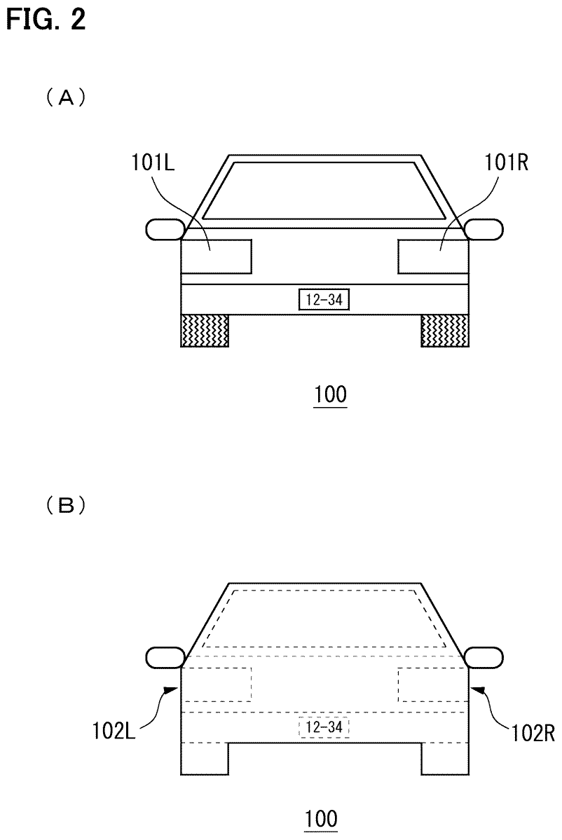

FIG. 2(A) is a diagram for explaining light source information of a forward vehicle detected by the camera. Here, as an example of a forward vehicle, a state in which a rear portion of a preceding vehicle is viewed from the own vehicle is shown in a schematic plane view. A preceding vehicle 100 includes a pair of taillights 101L and 101R disposed on the left and right of the rear portion. Camera 11 performs image processing on an image obtained by photographing the front space of the own vehicle, and thereby extracts a pixel group having luminance equal to or greater than a predetermined value as a light source (light emitting portion). As a result, the positions of the pair of taillights 101L and 101R are detected. Furthermore, based on the parallax on the stereo image of the extracted pixel groups, the relative distance from the own vehicle to preceding vehicle 100 is detected using the publicly known principle of triangulation. Here, although the illustration and detailed description are omitted, also in a case of an oncoming vehicle, the positions of a pair of headlights included in the oncoming vehicle are detected in the same manner, and the relative distance between the oncoming vehicle and the own vehicle is detected.

FIG. 2(B) is a diagram for explaining object information of a forward vehicle detected by the camera. Here, as an example of a forward vehicle, a situation in which the rear portion of a preceding vehicle viewed from the own vehicle is shown in a schematic plane view, but the same applies to a case of an oncoming vehicle. Camera 11 extracts an outer edge portion (contour portion) of preceding vehicle 100 by performing image processing on an image obtained by photographing the front space of the own vehicle. For example, vehicle shape detection can be achieved by extracting features in advance from information such as horizontal line feature, vertical line feature, luminance, color, and contrast and performing machine learning. From the extracted outer edge portion, for example, the left end portion 102L and the right end portion 102R of preceding vehicle 100 are detected as the left and right positions of preceding vehicle 100.

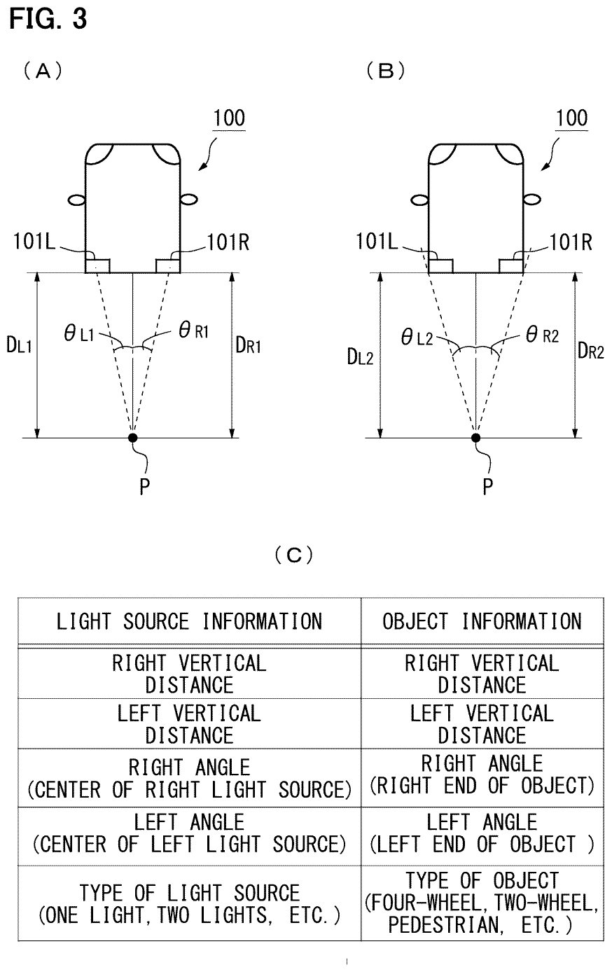

FIG. 3(A) is a diagram for specifically explaining light source information. Here, preceding vehicle 100 is shown in a schematic top view. As shown in the figure, the left angle θ_{L1}, right angle θ_{R1}, left longitudinal distance D_{L1}, right longitudinal distance D_{R1} are detected as the light source information. The left angle θ_{L1} is an angle indicating a relative position of taillight 101L with respect to the position P of camera 11, and specifically, is an angle indicating a substantially center position of taillight 101L in the left-right direction. The right angle θ_{R1} is an angle indicating a relative position of taillight 101R with respect to the position P of camera 11, and specifically, is an angle indicating a substantially center position of taillight 101R in the left-right direction. The left vertical distance D_{R1} is a relative distance to taillight 101L based on the position P of camera 11. The right vertical distance D_{R1} is a relative distance to taillight 101R based on the position P of camera 11. Here, although the illustration and the detailed description are omitted, also in a case of an oncoming vehicle, the left angle and the right angle corresponding to the positions of a pair of headlights included in the oncoming vehicle are detected in the same manner, and the left vertical distance and the right vertical distance, which are the relative distances between the oncoming vehicle and the own vehicle, are detected.

FIG. 3(B) is a diagram for specifically explaining object information. Here, preceding vehicle 100 is shown in a schematic top view. As shown in the figure, a left angle θ_{L2}, a right angle θ_{R2}, a left longitudinal distance D_{L2}, a right longitudinal distance D_{R2} are detected as the object information. The left angle θ_{L2} is an angle indicating a relative position of taillight 101L with respect to the position P of camera 11, and specifically, is an angle indicating the position of the left end 102L (refer to FIG. 2(B)) of preceding vehicle 100. The right angle θ_{R2} is an angle indicating a relative position of taillight 101R with respect to the position P of camera 11, and specifically, is an angle indicating the position of the right end portion 102R (refer to FIG. 2(B)) of preceding vehicle 100. The left vertical distance D_{L2} is a relative distance to taillight 101L based on the position P of camera 11. The right vertical distance D_{R2} is a relative distance to taillight 101R based on the position P of camera 11. Here, although the illustration and detailed description are omitted, also in a case of an oncoming vehicle, the left angle and the right angle corresponding to the positions of a pair of headlights included in the oncoming vehicle are detected in the same manner, and the left vertical distance and the right vertical distance, which are the relative distances between the oncoming vehicle and the own vehicle, are detected.

FIG. 3(C) is a diagram for explaining data structure of the light source information and the object information. The light source information includes the right vertical distance, the left vertical distance, the right angle, the left angle, and the type of light source as described above. The type of light source indicates the type of detected light source, and is, for example, contents such as one light or two lights. Typically, one light corresponds to a two-wheel vehicle, and the two lights correspond to a four-wheel vehicle. These data are detected as one set of light source information corresponding to one vehicle. Further, the object information includes the right vertical distance, the left vertical distance, the right angle, the left angle, and the type of object as described above. The type of object indicates the type of detected object, and is, for example, contents such as a four-wheel vehicle, a two-wheel vehicle, or a pedestrian. These data are detected as one set of object information corresponding to one vehicle.

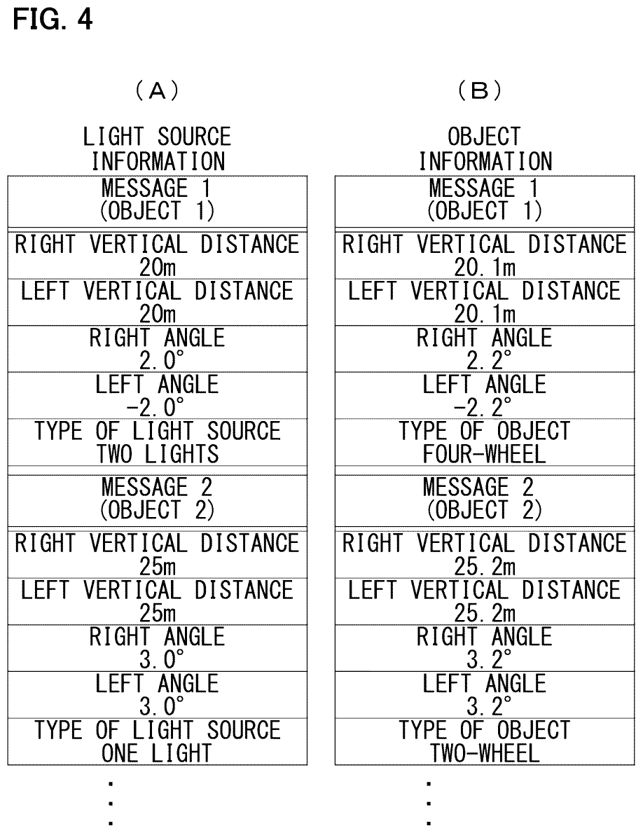

FIG. 4 (A) is a diagram for explaining an example of transmission data of the light source information. The light source information is packaged for each detected object and transmitted as one message from camera 11 to controller 10. For example, a message 1 corresponding to a first object (object 1) is transmitted, and then a message 2 corresponding to the second object (object 2) is transmitted. In the illustrated example, message 1 includes data of a right vertical distance “20 m”, a left vertical distance “20 m”, a right angle “2.0°”, a left angle “−2.0°”, and a type of light source “two lights”, and message 2 includes data of a right vertical distance “25 m”, a left vertical distance “25 m”, a right angle “3.0”, a left angle “3.0°”, and a type of light source “one light”.

FIG. 4(B) is a diagram for explaining an example of transmission data of the object information. The object information is packaged for each detected object and transmitted as one message from camera 11 to controller 10. For example, a message 1 corresponding to the first object (object 1) is transmitted, and then a message 2 corresponding to the second object (object 2) is transmitted. In the illustrated example, message 1 includes data of a right vertical distance “20.1 m”, a left vertical distance “20.1 m”, a right angle “2.2°”, a left angle “−2.2°”, and a type of object “four-wheel”, and message 2 includes data of a right vertical distance “25.2 m”, a left vertical distance “25.2 m”, a right angle “3.2°”, a left angle “3.2°”, and a type of object “two-wheel”.

Here, in the present embodiment, the light source information and the object information are not associated with each other. That is, for example, “object 1” in the light source information and “object 1” in the object information do not necessarily indicate the same object, and may indicate different objects. Therefore, as will be described in detail later, in the present embodiment, controller 10 determines whether the light source information and the object information are identical.

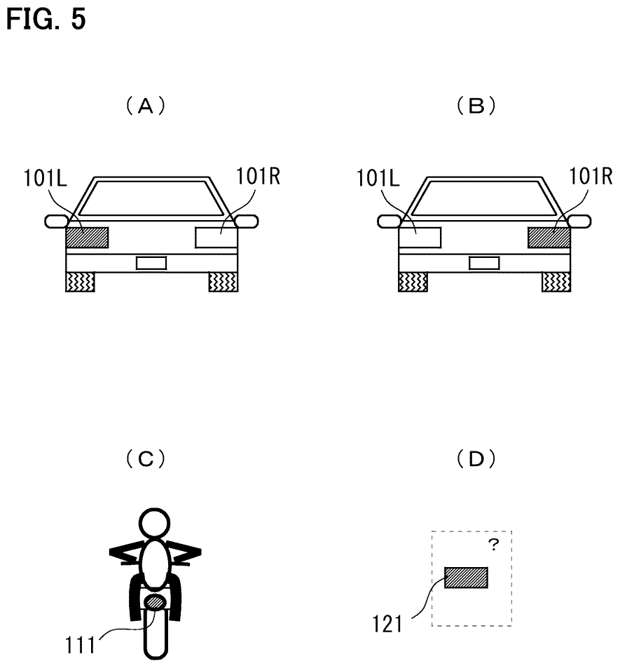

FIG. 5(A) to FIG. 5(D) are diagrams for explaining a situation assumed when “one light” is detected as the light source information. FIG. 5(A) illustrates a situation in which the actual object is a four-wheel vehicle, and the type of object is detected as “four-wheel”, but the taillight 101R is not detected as a light source due to a failure, shielding, or the like, and the type of light source is detected as “one light”. Similarly, FIG. 5(B) illustrates a situation in which the actual object is a four-wheel vehicle, and the type of object is detected as “four-wheel”, but the taillight 101L is not detected as a light source due to a failure, shielding, or the like, and the type of light source is detected as “one light”. In these situations, correction is required because glare may occur when a dimming range corresponding to “one light” is set.

On the other hand, as shown in FIG. 5(C), in a situation in which the actual object is a two-wheel vehicle and taillight 111 is detected, the type of light source is “one light” and the type of object is “two-wheel”, the dimming range corresponding to the “one light” may be set, and thus correction is not required. Further, as shown in FIG. 5(D), for example, by detecting lighting or the like on the side of the road, the type of light source is “one light” and in a situation where the type of object is “none”, it is not necessary to set the dimming range.

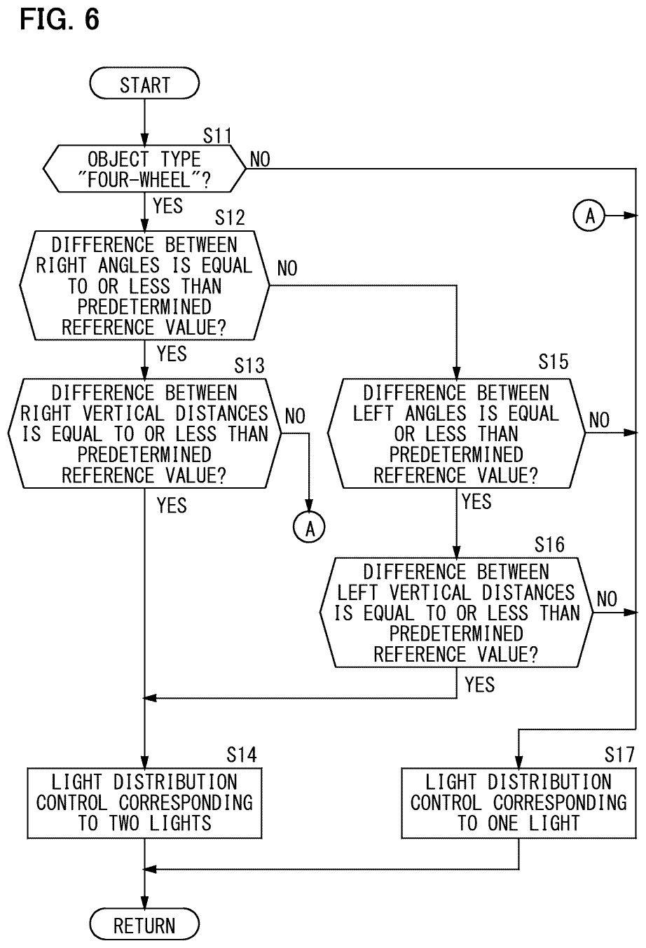

FIG. 6 is a flowchart showing an operation procedure of a vehicle headlight system. Here, it should be noted that the order of the processes shown here can be changed as long as no contradiction or inconsistency occurs in the result of the information processing, and other processes not explicitly described here can also be added. Here, mainly, “four-wheel” is obtained as the type of object, but an operation procedure in a case where “one light” is obtained as the type of light source will be described.

Vehicle detection unit 20 of controller 10 receives each data of the light source information and the object information transmitted from camera 11 at any time. When the type of object included in the object information of object 1 received from camera 11 is “four-wheel” (step S11; YES), vehicle detection unit 20 obtains the difference between the right angle included in the object information of object 1 and the right angle included in the light source information of all the received objects (for example, objects 1 and 2).

When there is light source information in which the difference between the right angles is equal to or less than a predetermined reference value (first reference value) (step S12; YES), vehicle detection unit 20 obtains the difference between the right vertical distance of the light source information and the right vertical distance included in the object information of object 1. The reference value is appropriately set based on the results of experiments, simulations, and the like (the same applies to each reference value described below).

Here, when there are a plurality of light source information in which the difference of the right angles is equal to or less than the reference value between the object information of object 1 and all the received objects, the light source information having the smallest difference between the right angles is specified as the information corresponding to the same object, and thereafter, the specified light source information is used as the information corresponding to object 1.

When the difference between the right vertical distances is equal to or less than a predetermined reference value (third reference value) (step S13; YES), vehicle detection unit 20 calculates the left and right light source positions of the forward vehicle by performing a predetermined calculation described later in detail, and outputs the data related to the light source position to light distribution pattern setting unit 21. Light distribution pattern setting unit 21 sets a light distribution pattern having a dimming range corresponding to the input position of the forward vehicle, and outputs the light distribution pattern to control signal generation unit 22. Accordingly, light distribution control having a dimming range corresponding to the forward vehicle having two light sources is realized (step S14). Thereafter, the process returns to step S11.

On the other hand, when the difference between the right angles is not equal to or less than the reference value (step S12; NO), vehicle detection unit 20 obtains the difference between the left angle included in the object information of the object 1 and the left angle included in the light source information of all the received objects (for example, objects 1 and 2).

When there is light source information in which the difference between the left angles is equal to or less than a predetermined reference value (second reference value) (step S15; YES), vehicle detection unit 20 obtains the difference between the left vertical distance of the light source information and the left vertical distance included in the object information of object 1.

Here, when there are a plurality of light source information in which the difference of the left angles is equal to or less than the reference value between the object information of the object 1 and all the received objects, the light source information having the smallest difference between the left angles is specified to correspond to the same object, and then the specified light source information is used as the object corresponding to the object 1.

When the difference between the left vertical distances is equal to or less than a predetermined reference value (fourth reference value) (step S16; YES), vehicle detection unit 20 calculates the left and right light source positions of the forward vehicle by performing a predetermined calculation described later in detail, and outputs the data related to the light source position to light distribution pattern setting unit 21. Light distribution pattern setting unit 21 sets a light distribution pattern having a dimming range corresponding to the input position of the forward vehicle, and outputs the light distribution pattern to control signal generation unit 22. Accordingly, light distribution control having a dimming range corresponding to the forward vehicle having the two light sources is realized (step S14). Thereafter, the process returns to step S11.

On the other hand, when the type of object is “two-wheel” rather than “four-wheel” (step S11; NO), or when the difference between the right vertical distances is not equal to or less than the reference value (S13; NO), or when the difference between the left angles is not equal to or less than the reference value (step S15; NO), or when the difference between the left vertical distances is not equal to or less than the reference value (step S16; NO), vehicle detection unit 20 outputs data relating to the left and right light source positions of the forward vehicle to light distribution pattern setting unit 21. Light distribution pattern setting unit 21 sets a light distribution pattern having a dimming range corresponding to the input position of the forward vehicle, and outputs the light distribution pattern to control signal generation unit 22. Accordingly, light distribution control having a dimming range corresponding to the forward vehicle having the light source of one light is realized (step S17). Thereafter, the process returns to step S11.

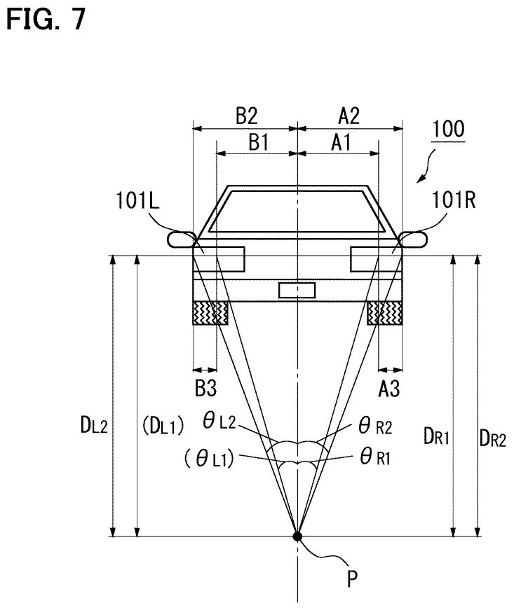

FIG. 7 is a diagram for explaining a specific example of light distribution control executed in step S14 described above. Here, it is assumed that the left angle θ_{L1} and the left longitudinal distance D_{R1} of taillight 101L in the light source information are not detected. Specifically, since the type of light source is “one light”, the left angle θ_{L1} is detected as the same value as the right angle θ_{R1}, but based on the fact that the difference from the left angle in the object information is not equal to or less than the reference value, it is assumed that the left angle θ_{L1} is inaccurate and is unusable. Further, for the same reason, a situation is assumed in which it is determined that the left vertical distance Du is also unusable. Further, it is assumed that D_{R1}=D_{R2} and D_{L1}=D_{L2}. Since it is confirmed that the difference between them is equal to or less than the reference value, these values are set to the same value for simplification of calculation.

Here, in this example, taillight 101R corresponds to a “first light-emitting portion”, right angle θ_{R1} corresponds to a “first position”, taillight 101L corresponds to a “second light-emitting portion”, left angle θ_{L1} calculated by the calculation described below corresponds to a “second position”, right angle θ_{R2} corresponds to a “right end position”, left angle θ_{L2} corresponds to a “left end position”, right vertical distance D_{R1} corresponds to a “third distance”, right vertical distance D_{R2} corresponds to a “first distance”, and the left vertical distance D_{L2} corresponds to a “second distance”.

As shown in the figure, taking the direction of travel of the own vehicle which passes through position P of camera 11 as a reference, assuming that the distance from the reference to the center of taillight 101R is A1, the distance to the right end of forward vehicle 100 is A2, the distance from the reference to the center of taillight 101L is B1, the distance to the left end of forward vehicle 100 is B2, the difference between A1 and A2 is A3, and the difference between B1 and B2 is B3, these distances can be expressed as follows.

$$\begin{matrix}A 1 = tan {θ}_{R 1} \times {D}_{R 1} \\ = tan {θ}_{R 1} \times {D}_{R 2}\end{matrix}$$

$$A 2 = tan {θ}_{R 2} \times {D}_{R 2}$$

$$A 3 = A 2 - A 1$$

$$B 2 = tan {θ}_{L 2} \times {D}_{L 2}$$

$$B 3 {=}_{.}^{.} A 3$$

$$\begin{matrix}B 1 = B 2 - B 3 \\ = B 2 - A 3\end{matrix}$$

Therefore, θ_{L1} is obtained as follows.

$$\begin{matrix}{θ}_{L 1} = {tan}^{- 1} ( B 1 / {D}_{L 1} ) \\ = {tan}^{- 1} ( B 1 / {D}_{L 2} )\end{matrix}$$

Here, note that, in a situation in which right angle θ_{R1} and right vertical distance D_{R1} of taillight 101R in the light source information are not detected, the geometric arrangement in the above-described calculation is only reversed in the left-right direction, and thus can be calculated in the same manner. The same applies to a case where the light source information corresponds to the headlight of the forward vehicle.

Based on such calculation, θ_{L1} and θ_{R1}, which are angles indicating the center positions of taillights 101L and 101R, are obtained, and thus it is possible to set a more appropriate dimming range by using θ_{L1} and θ_{R1}. A publicly known method (for example, a method described in Japanese Patent Application Laid-Open No. 2022-167566) can be appropriately used for setting the light distribution pattern using θ_{L1} and θ_{R1}, which are angles indicating the center positions of taillights 101L and 101R, and thus detailed description thereof will be omitted here.

Here, when the type of object is “four-wheel” and the type of light source is “two lights”, a publicly known method (for example, a method described in Japanese Patent Application Laid-Open No. 2022-167566) is appropriately used to execute light distribution control in which a light distribution pattern having a dimming range corresponding to the position of the forward vehicle is set. Similarly, even when the type of object is “two-wheel” and the type of light source is “one lamp”, the publicly known method is appropriately used to execute light distribution control in which a light distribution pattern having a dimming range corresponding to the position of the forward vehicle is set.

FIG. 8 (A) is a diagram for explaining an example of a light distribution pattern realized by the present embodiment. As illustrated in FIG. 8 (A), in the vehicle headlight system of the present embodiment, even when one of the light source (a taillight in the illustrated example, but may be a headlight as well) of the forward vehicle is turned off due to a failure or the like or is not detected as a pair of light sources by being shielded by something, by including the type of object in the determination, the system generates an illumination light 150 having an appropriate dimming range 151 corresponding to the position of the forward vehicle. As a result, glare to the forward vehicle is prevented or reduced. Here, it should be noted that “dimming” also includes turning the light off.

FIG. 8(B) is a diagram for explaining a light distribution pattern of a comparative example. In the comparative example shown in FIG. 8(B), when only one of the pair of light sources of the forward vehicle is detected, an irradiation light 150a having a dimming range 151a in a relatively narrow range corresponding to the position of the light source is formed. For this reason, there is a possibility of causing glare to the forward vehicle.

According to the present embodiment as described above, it is possible to obtain a light distribution control technology capable of more appropriately setting a dimming range according to the situation of the forward vehicle.

Here, the present disclosure is not limited to the contents of the above-described embodiment, and can be variously modified and implemented within the scope of the gist of the present disclosure. For example, in the above-described embodiment, camera 11 is cited as an example of a sensor in which the first sensor and the second sensor for detecting the position of the forward vehicle and the like are integrated, but the configuration of the sensor is not limited thereto. For example, a sensor by a light sensing technology such as light detection and ranging (LIDAR) may be used, or a sensor such as a millimeter wave radar may be used as well. Further, these sensors may be used in combination, and the light source information and the object information may be detected by separate sensors.

The present disclosure has features as appended below.

### APPENDIX 1

A control apparatus for a vehicle headlight in which a light distribution pattern is variable including:
a first sensor configured to detect at least a first position indicating a position of a first light-emitting portion of a forward vehicle;
a second sensor configured to detect a right end position and a left end position of the forward vehicle as seen from an own vehicle, a first distance indicating a relative distance between the right end position and the own vehicle, and a second distance indicating a relative distance between the left end position and the own vehicle, and
a controller configured to connect each of the first sensor, the second sensor, and the vehicle headlight, and configured to control the operation of the vehicle headlight;
wherein, when the difference between the first position and the right end position is equal to or less than a first reference value or when the difference between the first position and the left end position is equal to or less than a second reference value, the controller obtains a second position indicating a position of a second light-emitting portion of the forward vehicle that is not detected by the first sensor on the basis of the first position, the right end position, the left end position, the first distance, and the second distance, sets a light distribution pattern having a dimming range corresponding to the position of the forward vehicle by using the first position and the second position, and generates a control signal corresponding to the light distribution pattern and supplies it to the vehicle headlight.

### APPENDIX 2

The control apparatus for a vehicle headlight according to appendix 1,
wherein the first sensor is configured to further detect a third distance indicating a relative distance between the first light-emitting portion and the own vehicle, and
wherein, when the difference between the third distance and the first distance is equal to or less than the third reference value or the difference between the third distance and the second distance is equal to or less than a fourth reference value, the controller sets a light distribution pattern having a dimming range corresponding to the position of the forward vehicle by using the first position and the second position, and generates a control signal corresponding to the light distribution pattern and supplies it to the vehicle headlight.

### APPENDIX 3

The control apparatus for a vehicle lamp according to appendix 1 or 2,
wherein, when the difference between the first position and the right end position is not equal to or less than a first reference value or the difference between the first position and the left end position is not equal to or less than a second reference value, the controller sets a light distribution pattern having a dimming range corresponding to the position of the forward vehicle by using the first position, and generates a control signal corresponding to the light distribution pattern and supplies it to the vehicle headlight.

### APPENDIX 4

The control apparatus for a vehicle headlight according to appendix 2,
wherein, when the difference between the third distance and the first distance is not equal to or less than a third reference value or the difference between the third distance and the second distance is not equal to or less than a fourth reference value, the controller sets a light distribution pattern having a dimming range corresponding to the position of the forward vehicle by using the first position, and generates a control signal corresponding to the light distribution pattern and supplies it to the vehicle headlight.

### APPENDIX 5

The control apparatus for a vehicle headlight according to any one of appendices 1 to 4,
wherein the first position indicates a position corresponding to a substantially center of the first light-emitting portion in the left-right direction, and
the second position indicates a position corresponding to a substantially center of the second light-emitting portion in the left-right direction.

### APPENDIX 6

The control apparatus for a vehicle headlight according to any one of appendices 1 to 5,
wherein the right end position and the left end position are detected based on an outer edge portion of the forward vehicle as viewed from the own vehicle.

### APPENDIX 7

The control apparatus for a vehicle headlight according to any one of appendices 1 to 6,
wherein the first sensor and/or the second sensor is a camera having an image processing function.

### APPENDIX 8

The control apparatus for a vehicle headlight according to appendix 7,
wherein the first sensor and the second sensor are integrally configured.

### APPENDIX 9

A control method executed by a controller connected to a vehicle headlight with a variable light distribution pattern,
wherein the controller is connected to a first sensor configured to detect a first position indicating the position of a first light-emitting portion of a forward vehicle, and a second sensor configured to detect a right end position and a left end position of the forward vehicle as seen from an own vehicle, a first distance indicating a relative distance between the right end position and the own vehicle, and a second distance indicating a relative distance between the left end position and the own vehicle, and
wherein, when the difference between the first position and the right end position is equal to or less than a first reference value or when the difference between the first position and the left end position is equal to or less than a second reference value, the controller executes to obtain a second position indicating a position of a second light-emitting portion of the forward vehicle that is not detected by the first sensor on the basis of the first position, the right end position, the left end position, the first distance, and the second distance,
to set a light distribution pattern having a dimming range corresponding to the position of the forward vehicle by using the first position and the second position, and
to generate a control signal corresponding to the light distribution pattern and supplies it to the vehicle headlight.

### APPENDIX 10

A vehicle headlight system including:
the control apparatus according to any one of appendices 1 to 8, and
a vehicle headlight controlled by the control apparatus.

### DESCRIPTION OF REFERENCE NUMERALS

10: Controller
11: Camera
12L, 12R: Headlight unit
20: Vehicle detection unit
21: Light distribution pattern setting unit
22: Control signal generation unit

1. A control apparatus for a vehicle headlight in which a light distribution pattern is variable comprising:
a first sensor configured to detect at least a first position indicating a position of a first light-emitting portion of a forward vehicle;
a second sensor configured to detect a right end position and a left end position of the forward vehicle as seen from an own vehicle, a first distance indicating a relative distance between the right end position and the own vehicle, and a second distance indicating a relative distance between the left end position and the own vehicle, and
a controller configured to connect each of the first sensor, the second sensor, and the vehicle headlight, and configured to control the operation of the vehicle headlight;
wherein, when the difference between the first position and the right end position is equal to or less than a first reference value or when the difference between the first position and the left end position is equal to or less than a second reference value, the controller obtains a second position indicating a position of a second light-emitting portion of the forward vehicle that is not detected by the first sensor on the basis of the first position, the right end position, the left end position, the first distance, and the second distance, sets a light distribution pattern having a dimming range corresponding to the position of the forward vehicle by using the first position and the second position, and generates a control signal corresponding to the light distribution pattern and supplies it to the vehicle headlight.

2. The control apparatus for a vehicle headlight according to claim 1,
wherein the first sensor is configured to further detect a third distance indicating a relative distance between the first light-emitting portion and the own vehicle, and
wherein, when the difference between the third distance and the first distance is equal to or less than the third reference value or the difference between the third distance and the second distance is equal to or less than a fourth reference value, the controller sets a light distribution pattern having a dimming range corresponding to the position of the forward vehicle by using the first position and the second position, and generates a control signal corresponding to the light distribution pattern and supplies it to the vehicle headlight.

3. The control apparatus for a vehicle headlight according to claim 1,
wherein, when the difference between the first position and the right end position is not equal to or less than a first reference value or the difference between the first position and the left end position is not equal to or less than a second reference value, the controller sets a light distribution pattern having a dimming range corresponding to the position of the forward vehicle by using the first position, and generates a control signal corresponding to the light distribution pattern and supplies it to the vehicle headlight.

4. The control apparatus for a vehicle headlight according to claim 2,
wherein, when the difference between the third distance and the first distance is not equal to or less than a third reference value or the difference between the third distance and the second distance is not equal to or less than a fourth reference value, the controller sets a light distribution pattern having a dimming range corresponding to the position of the forward vehicle by using the first position, and generates a control signal corresponding to the light distribution pattern and supplies it to the vehicle headlight.

5. The control apparatus for a vehicle headlight according to claim 1,
wherein the first position indicates a position corresponding to a substantially center of the first light-emitting portion in the left-right direction, and
the second position indicates a position corresponding to a substantially center of the second light-emitting portion in the left-right direction.

6. The control apparatus for a vehicle headlight according to claim 1,
wherein the right end position and the left end position are detected based on an outer edge portion of the forward vehicle as viewed from the own vehicle.

7. The control apparatus for a vehicle headlight according to claim 1,
wherein the first sensor and/or the second sensor is a camera having an image processing function.

8. The control apparatus for a vehicle headlight according to claim 7,
wherein the first sensor and the second sensor are integrally configured.

9. A control method executed by a controller connected to a vehicle headlight with a variable light distribution pattern,
wherein the controller is connected to a first sensor configured to detect a first position indicating the position of a first light-emitting portion of a forward vehicle, and a second sensor configured to detect a right end position and a left end position of the forward vehicle as seen from an own vehicle, a first distance indicating a relative distance between the right end position and the own vehicle, and a second distance indicating a relative distance between the left end position and the own vehicle, and
wherein, when the difference between the first position and the right end position is equal to or less than a first reference value or when the difference between the first position and the left end position is equal to or less than a second reference value, the controller executes to obtain a second position indicating a position of a second light-emitting portion of the forward vehicle that is not detected by the first sensor on the basis of the first position, the right end position, the left end position, the first distance, and the second distance,
to set a light distribution pattern having a dimming range corresponding to the position of the forward vehicle by using the first position and the second position, and
to generate a control signal corresponding to the light distribution pattern and supplies it to the vehicle headlight.

10. A vehicle headlight system comprising:
the control apparatus according to claim 1, and
a vehicle headlight controlled by the control apparatus.
